(19) United States
(12) Patent Application Publication
(10) Pub. No.: US 2008/0143834 A1
(43) Pub. Date: Jun. 19, 2008

(54) METHOD AND APPARATUS FOR TESTING AND MONITORING DRIVER PROFICIENCY, SAFETY AND PERFORMANCE

(76) Inventors: David Arthur Comeau, Sussex, WI (US); Bill Nicholson, Sussex, WI (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/871,133

(22) Filed: Oct. 11, 2007

Related U.S. Application Data
(60) Provisional application No. 60/829,134, filed on Oct. 11, 2006.

(51) Int. Cl. H04N 7/18

(52) U.S. Cl. 348/148; 348/E07.085

(57) ABSTRACT

A system for evaluating and monitoring driver proficiency, performance and safety is disclosed. The system includes an apparatus having a controller that is in operative association with one or more video cameras mounted within a vehicle for providing audio/video data to the controller as well as with an OBD connection for the collection and transmission of vehicle data from the vehicle to the controller. The controller further includes a microprocessor for synchronizing the recorded vehicle data from the vehicle with the video/audio data collected from the video cameras in order to evaluate and monitor a driver's performance and proficiency.

### CROSS REFERENCE TO RELATED APPLICATION

This application claims priority to U.S. Provisional Application No. 60/829,134 filed on Oct. 11, 2006.

### FIELD

The present document relates to a system and related method for monitoring and testing driver proficiency, driver safety, and driver performance during the operation of a vehicle.

### BACKGROUND

Conventional driver testing for obtaining a driver's license requires that an evaluator, such as a law enforcement officer or government official, be present in order to monitor and evaluate the driver's response to various driving tasks. Successful completion of these driving tasks, like parallel parking and general driving skills, must be closely monitored and evaluated by the evaluator to ensure that the driver being tested has successfully completed these driving tasks to determine whether a license may be issued to the driver. However, such an evaluation of a driver's skills is completely subjective and dependent on the ability of the evaluator to accurately evaluate the performance of the driver being tested.

In addition, companies that use commercial drivers to make deliveries or provide driving services have an interest in ensuring the proper driving performance of these drivers. For example, commercial drivers that drive erratically or come into conflict with other drivers on the road can produce bad publicity for the company. Companies with commercial drivers also may want to know the circumstances surrounding a car accident involving one of their drivers in order to better assess the liability issues.

As such, there is a need in the art for a system to monitor and evaluate drivers from a driver proficiency, performance and safety standpoint.

### SUMMARY

In one embodiment, a system for monitoring and evaluating a driver operating a vehicle may include an apparatus having a controller adapted to be used inside the vehicle being operated by the driver with the controller including a microprocessor in operative communication with a module. At least one video camera in operative association with the microprocessor for providing audio/video data related to the driver and/or road conditions outside the vehicle to the module and an OBD connection for obtaining vehicle data from the vehicle with the vehicle data being transmitted from the OBD connection to the module. The module synchronizes the audio/video data from the at least one video camera with the vehicle data from the OBD connection to produce a synchronized data such that the vehicle data is matched with the corresponding audio/video data that was concurrently recorded at the same time.

In another embodiment, an apparatus for monitoring and evaluating a driver operating a vehicle may include a controller adapted to be used inside a vehicle being operated by a driver with the controller having a microprocessor in operative communication with a module for processing data and a touch screen for enabling operation of the apparatus. A plurality of video cameras may be in operative communication with the microprocessor for providing audio/video data of the interior and exterior of the vehicle to the module, and an OBD connection for obtaining vehicle data from the OBD port of the vehicle with the vehicle data being transmitted from the OBD connection to the module. The module synchronizes the audio/video data from the plurality of video cameras with the vehicle data collected from the OBD connection such that a synchronized data is generated having concurrently recorded vehicle data and the audio/video data.

In yet another embodiment, a method for evaluating and monitoring driver proficiency, safety and performance may include:

providing an apparatus having a controller adapted to be used inside a vehicle being operated by a driver with the controller having a microprocessor in operative communication with a module for processing data and a touch screen for enabling operation of the apparatus, a plurality of video cameras in operative communication with the microprocessor for providing audio/video data of the interior and exterior of the vehicle to the module, and an OBD connection for obtaining vehicle data from the OBD port of the vehicle;

mounting the plurality of video cameras such that at least one of the plurality of video cameras captures a view of the interior of the vehicle and/or at least another one of the plurality of video cameras captures a view of the road conditions around the exterior of the vehicle;

transmitting vehicle data from the OBD connection and audio/video data from the plurality of vehicles to the module; and

synchronizing the audio/video data from the plurality of video cameras with the vehicle data from the OBD connection such that a synchronized data is generated having concurrently recorded vehicle data and the audio/video data.

Additional objectives, advantages and novel features will be set forth in the description which follows or will become apparent to those skilled in the art upon examination of the drawings and detailed description that follows.

### BRIEF DESCRIPTION OF THE DRAWINGS

FIG. 1 is a perspective view of a evaluating and monitoring system operatively associated with a vehicle;

FIG. 2 is a perspective view of the apparatus of the evaluating and monitoring system;

FIG. 3 is a simplified block diagram illustrating operational components of the evaluating and monitoring system; and

FIG. 4 is a simplified block diagram illustrating a microprocessor associated with the apparatus of the evaluating and monitoring system.

Corresponding reference characters indicate corresponding elements among the several views. The headings used in the figures should not be interpreted to limit the scope of the figures.

### DETAILED DESCRIPTION

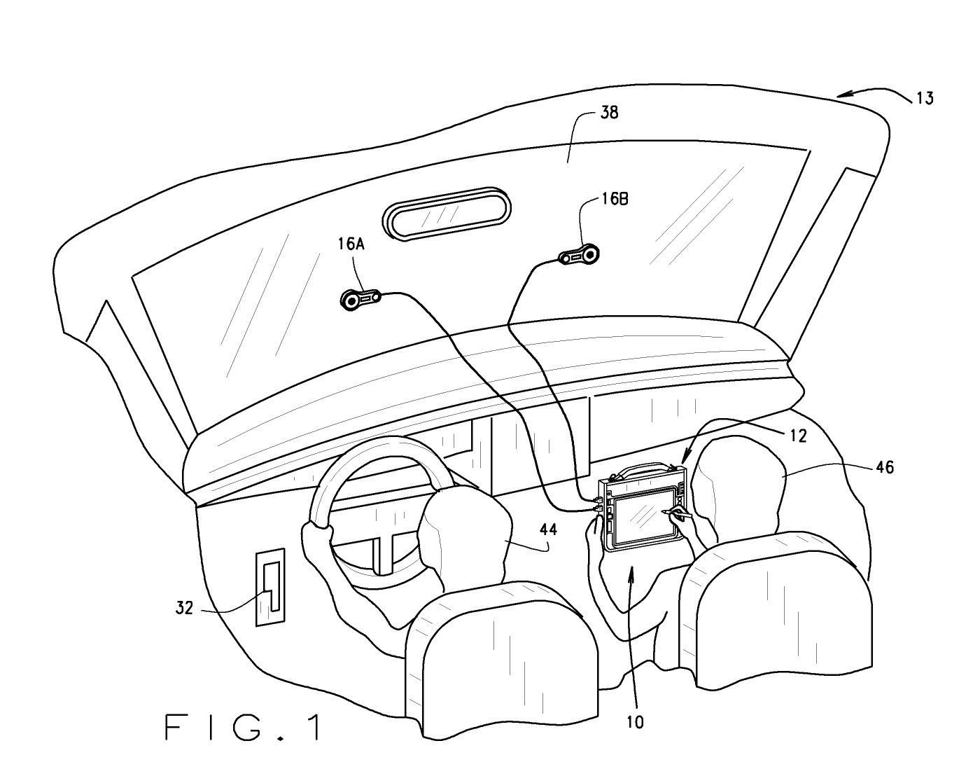

Referring to the drawings, an apparatus and method for implementing an evaluating and monitoring system is generally indicated as 10 in FIGS. 1-4. As shown in FIG. 1, the monitoring system 10 is capable of monitoring and evaluating driver proficiency, performance and safety. The evaluating and monitoring system 10 includes an apparatus 12 adapted for use inside a vehicle 13 for providing the monitoring and evaluating functions as shall be discussed in greater detail below.

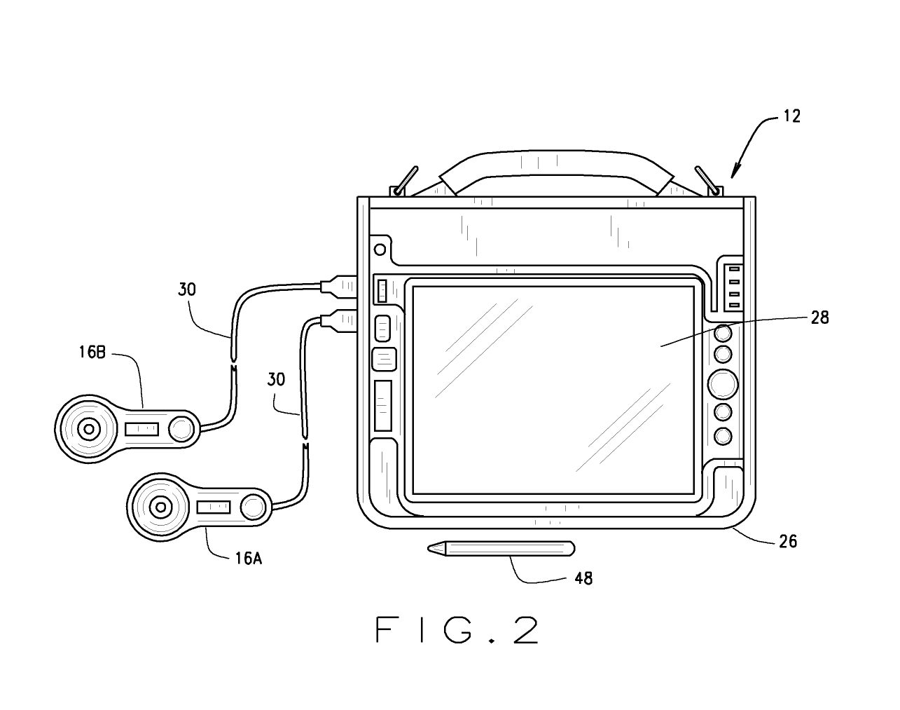

Referring to FIGS. 1 and 2, the apparatus 12 may include one or more video cameras 16 for recording the interior of the vehicle 13, and more particularly the driver 44, while one or more cameras 16 may record the exterior of the vehicle 13, such as the road conditions surrounding the vehicle 13. In one embodiment of the apparatus 12, there may only be one camera 16A, while another embodiment has two cameras 16A and 16B. Other embodiments may have a three or more video cameras 16 in order to produce audio/video data 40 at different viewing angles. The audio/video data 40 produced by the video cameras 16A and 16B may relate to the various angles showing the interior of the vehicle 13, such as a driver 44 and/or user 46 of the apparatus 12. In one embodiment, the video cameras 16A and 16B allow for simultaneous recording of multiple views, such as the driver and driver's view in front or behind the vehicle 13. As such, the video cameras 16A or 16B may also be mounted in order to monitor road conditions.

In one embodiment, the video cameras 16A and 16B may have a video capture capability of 640×480 pixels, although additional video resolution may be utilized. In another embodiment, RightLight™ technology for clear viewing of daytime and low light viewing of the video signal may be employed with the video cameras 16A and 16B.

As further shown, the apparatus 12 may include a housing 26 having a touch screen 28 for operating the various functionalities of the monitoring system 10. The apparatus 12 may further include a stylus 48 adapted to operate the touch screen 28 by engaging certain portions of the touch screen 28 in order to actuate certain functionalities In one embodiment, wires 30 operatively engage the apparatus 12 with the video cameras 16A and 16B in order to transmit audio and video data 40, although other embodiments may contemplate a wireless communication between the video cameras 16A and 16B and the apparatus 12. If desired, custom camera mounts (not shown) may be installed on the vehicle 13 to permit fast and easy insertion and removal of cameras 16A and 16B, while suction cups (not shown) may be used to attach the cameras 16A and 16B to appropriate surfaces.

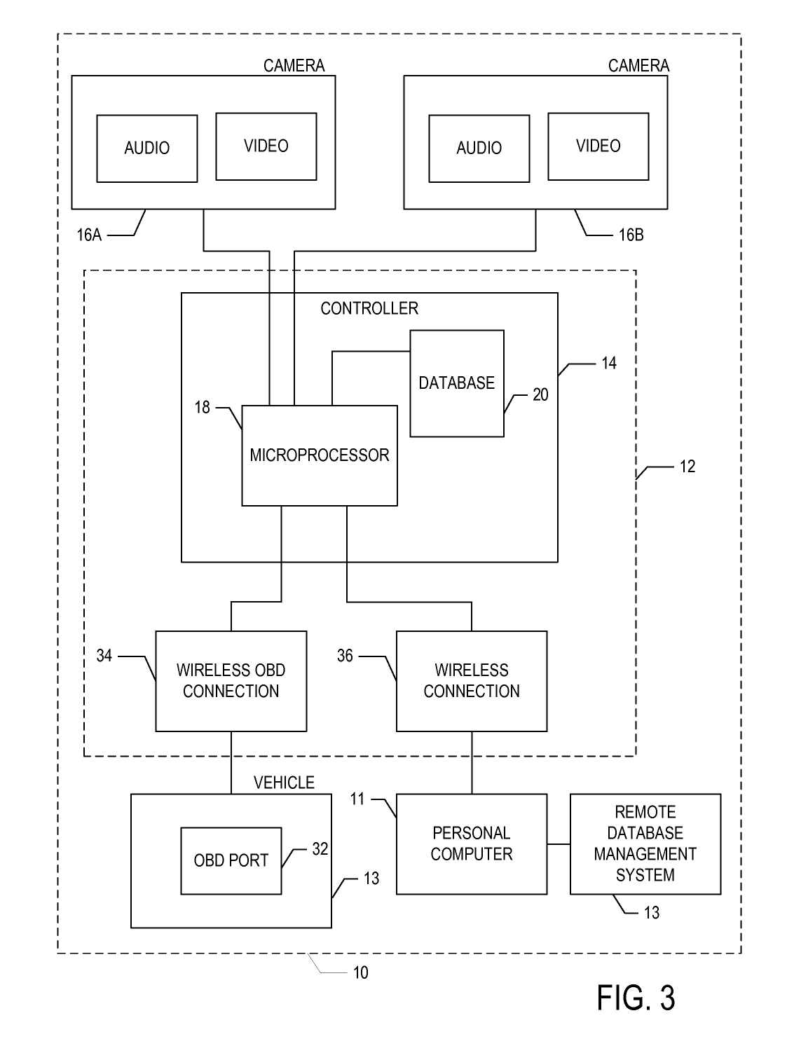

Referring to FIG. 3, the apparatus 12 further includes a controller 14 that has a microprocessor 18 in operative association with a database 20 in addition to other electronic components for enabling the operation of the apparatus 12. In one embodiment, the controller 14 may have a wireless OBD connection 34 adapted for operative engagement with the OBD port 32 of the vehicle 13 for collecting and transmitting vehicle data 42 to the controller 14, while in another embodiment, there may be a OBD connection 34 that is physically engaged to an OBD port through wiring. The apparatus 12 may include support for all protocols on OBDII equipped vehicles 13 including CAN, VPW, PWM, ISO, KEYWORD, etc.

In one embodiment, the controller 14 may be a desktop personal computer that sits in the vehicle 13 during the operation of the vehicle 13 by the driver 44. In an alternative embodiment, the controller 14 could be a LINUX personal computer that could also be used inside the vehicle 13 as well as other types of personal computers that may operate in the vehicle 13, such as an industrial personal computer, computer board, or any other type of personal computer controller that may control the various functions of the apparatus 12. The microprocessor 18 may also be any type of custom designed microcontroller or microprocessor controller that will control the functionalities of the apparatus 12 and allow for the monitoring, collection, manipulation and storage of data 40 and 42. In another embodiment, any type of personal data assistant (PDA), cell phone or other type of intelligent device may be employed to control or implement the functionalities of the apparatus 12.

In one aspect, the OBD connection 34 may relay to the microprocessor 18 certain vehicle data 42, such as vehicle road speed, acceleration data, throttle position, and brake actuation data to the microprocessor 18. The collection of other vehicle data 42 using internal and external measurement sensors is also contemplated, for example, temperature measurements, pressure measurements, flow measurements and GPS measurements may be taken and transmitted to the microprocessor 18. The collection of vehicle 13 data by the OBD connection 34 through the OBD port 32 of the vehicle 13 permits the scientific unbiased judgment of events related to the driver's performance during operation of the vehicle 13, such as the expired time between the occurrence of an accident and the deceleration by the driver 44.

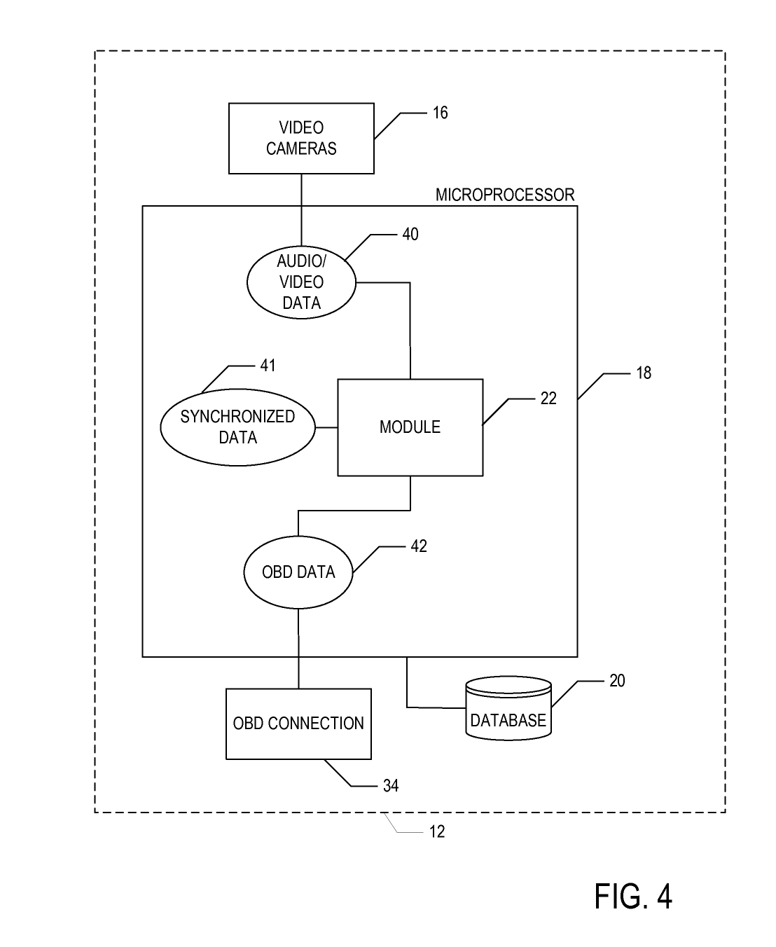

As shown in FIG. 4, the microprocessor 18 includes a module 22 that performs certain functionalities. In particular, the module 22 is in operative communication with the video cameras 16A and 16B for the collection, storage and manipulation of audio and video data 44 by the module 22. In addition, the module 22 is also in operative communication with a wireless OBD connection 34 for the collection, storage and manipulation of vehicle data 42 collected through the OBD port 32 of the vehicle 13. The microprocessor 18 may include a database 20 for the storage of various data received by the microprocessor 18. In addition, the microprocessor 18 may include a wireless or Ethernet connection 36 for downloading all data recorded in the vehicle 13 to a local personal computer 11 or PC network. Other functionalities that may be performed by the apparatus 12 are GPS mapping, data logging, etc.

The microprocessor 18 may be adapted to synchronize the audio/video signals 40 with the vehicle data 42 obtained through the OBD connection 34. In this embodiment, the vehicle data 42, such as speed and acceleration, may be synchronized to the audio/video data 40 utilizing a wide variety of synchronization methods so that synchronized data 41 is generated having concurrently recorded vehicle data 42 and audio/video data 40. This synchronized data 41 allows a person to judge the driving proficiency of the driver 44 operating the vehicle 13 by synchronizing the actions of the driver 44 operating the vehicle 13 contained in the vehicle data 42 with visual recording of the driver 44 contained in the audio/video data 40. This implementation allows for the automatic playback and evaluation of the synchronized data 41.

In one embodiment, the personal computer 11 may be in operative communication with a remote database management system 13 for the storage of data 40 and 42. The remote database management system 13 may include the capability to remotely store all recorded audio/video data 40 and OBD vehicle data 42. As such, the audio/video data 40 and OBD vehicle data 42 may be available to view and print online or transmitted to a corporate computer network (not shown).

In one aspect, the module 22 may be operable to have a built in user configurable pass/fail test or criteria that permits the automatic evaluation of the driver's performance based on audio/video data 40 and/or OBD vehicle data 42 collected by the microprocessor 18. The pass/fail test may be a driver's examination for a driver's license in a particular state for evaluating the proper operation of the vehicle 13 that allows a completely independent and unbiased examination of the driver's performance using the monitoring system 10. In other words, the apparatus 12 may solely evaluate the driver's performance without the need for an evaluator inside the vehicle is to perform a subjective analysis of that performance during the driver's evaluation. The criteria for evaluating a driver's performance may include, but not limited to, stopping, parallel parking, observing speed limits and making proper turns with the vehicle 13.

Further, the apparatus 12 may record data related to testing the reflexes of the driver 44 to determine the driver's ability to properly operate the vehicle 13 under certain conditions. For example, the apparatus 12 may record the timing of when a condition occurs visually to when the driver 44 actuates the brakes and/or slows down or changes the throttle position. The apparatus 12 may also allow the driver 44 and/or user 46 of the apparatus 12 to make notes on an item-by-item basis regarding the aspects of the driver's examination using the touch screen 28 of the apparatus 12. In another aspect, the apparatus 12 may monitor evaluating personnel or other user to assure that driver examinations are being conducted in a safe and fair manner. In a further aspect, the apparatus 12 may monitor and record the driving history for a commercial driver so that the company may later review the recorded audio/video data 40, vehicle data 42 or synchronized data 41.

As noted above, the module 22 records the performance of driver 44 taking the driver's test as well as evaluating personnel who may be evaluating the driver 44 during the performance of the driver's test. In one embodiment, a permanent record of the conversation between the driver 44 and evaluating personnel may be maintained in the database 20 for later review and evaluation. In another embodiment, the data 40 and 42 of the driver's performance collected by the apparatus 12 may be used as a learning tool to train new prospective drivers 44 based on their recorded performance. In one aspect, the cameras 16 may record traffic and road conditions during a driver's operation of the vehicle 13 in order to evaluate driver performance during hazardous road conditions. The apparatus 12 may also record any accidents and driver 44 actions during operation of vehicle when an accident occurred.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for monitoring and evaluating a driver operating a vehicle comprising:
an apparatus having a controller adapted to be used inside the vehicle being operated by the driver, the controller including a microprocessor in operative communication with a module;
at least one video camera in operative association with the microprocessor for providing audio/video data related to the driver and/or road conditions outside the vehicle to the module; and
an OBD connection for obtaining vehicle data from the vehicle, the vehicle data being transmitted from the OBD connection to the module,
wherein the module synchronizes the audio/video data from the at least one video camera with the vehicle data from the OBD connection to produce a synchronized data such that the vehicle data is matched with the corresponding audio/video data that was concurrently recorded at the same time.

2. The system of claim 1 wherein one or more measurements related to driver performance are derived from the vehicle data and matched with the corresponding audio/video data that was concurrently recorded at the same time.

3. The system of claim 2, wherein one or more certain measurements is a driver reflex time derived from the vehicle data and compared to a synchronized time frame of the audio/video data.

4. The system of claim 1, wherein the module includes criteria for passing or failing a driver's test being performed by the driver such that the vehicle data is compared to the criteria to determine a pass or fail determination.

5. The system of claim 1, wherein the video/audio data contains a permanent record of the conversation and instructions given during operation of the vehicle.

6. The system of claim 1, wherein the OBD connection is a wireless connection to an OBD port of the vehicle for collecting vehicle data.

7. The system of claim 1, wherein the ODD connection is a direct connection to an OBD port of the vehicle for collecting the vehicle data.

8. The system of claim 1, further including a remote database management system in operative communication with the microprocessor for storing vehicle data and audio/video data.

9. An apparatus for monitoring and evaluating a driver operating a vehicle comprising:
a controller adapted to be used inside a vehicle being operated by a driver, the controller having a microprocessor in operative communication with a module for processing data and a touch screen for enabling operation of the apparatus,
a plurality of video cameras in operative communication with the microprocessor for providing audio/video data of the interior and exterior of the vehicle to the module, and
an OBD connection for obtaining vehicle data from the OBD port of the vehicle, the vehicle data being transmitted from the OBD connection to the module,
wherein the module synchronizes the audio/video data from the plurality of video cameras with the vehicle data collected from the OBD connection such that a synchronized data is generated having concurrently recorded vehicle data and the audio/video data.

10. The apparatus of claim 9, wherein the module includes a criteria for passing or failing a driver's evaluation based on a comparison of the vehicle data with the criteria.

11. The apparatus of claim 9, wherein the audio/video data of the exterior of the vehicle shows the road conditions.

12. The apparatus of claim 9, wherein the audio/video data of the interior of the vehicle shows the driver.

13. A method for evaluating and monitoring driver proficiency, performance and safety comprising:
providing an apparatus comprising a controller adapted to be used inside a vehicle being operated by a driver, the controller having a microprocessor in operative communication with a module for processing data and a touch screen for enabling operation of the apparatus, a plurality of video cameras in operative communication with the microprocessor for providing audio/video data of the interior and exterior of the vehicle to the module, and an OBD connection for obtaining vehicle data from the OBD port of the vehicle,
mounting the plurality of video cameras such that at least one of the plurality of video cameras captures a view of the interior of the vehicle and/or at least another one of the plurality of video cameras captures a view of the road conditions around the exterior of the vehicle;
transmitting vehicle data from the OBD connection and audio/video data from the plurality of vehicles to the module; and
synchronizing the audio/video data from the plurality of video cameras with the vehicle data from the OBD connection such that a synchronized data is generated having concurrently recorded vehicle data and the audio/video data.
